(19) United States
(12) Patent Application Publication
(10) Pub. No.: US 2006/0188032 A1
(43) Pub. Date: Aug. 24, 2006

(54) Dual carrier modulator for modulating OFDM multi-carrier, OFDM transmitter therewith, and a method thereof

(75) Inventors: Hae-sik Kim, Seoul (KR); Jeong-sang Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/344,069

(22) Filed: Feb. 1, 2006

(30) Foreign Application Priority Data
Feb. 18, 2005 (KR) 10-2005-0013426

(51) Int. Cl. H04K 1/10

(52) U.S. Cl. 375/260

(57) ABSTRACT

A dual carrier modulator that modulates an orthogonal frequency division multiplexing (OFDM) carrier, includes an input part receiving a predetermined number of coded bits; a memory part storing the coded bits received through the input part; a detection part detecting four bits among the coded bits in a predetermined order; and an operation part generating a modulated symbol comprising a real part and an imaginary part, using the four detected bits and a predetermined unitary matrix. Here, one of the detected four bits is included in a real part of a first modulated symbol and in an imaginary part of a second modulated symbol. Accordingly, loss of signals caused by mismatching between an In-phase channel and a Quadrature channel can be prevented.

### CROSS-REFERENCE TO RELATED APPLICATIONS

This application claims priority from Korean Patent Application No. 10-2005-0013426 filed on Feb. 18, 2005 in the Korean Intellectual Property Office, the disclosure of which is incorporated herein by reference.

### BACKGROUND OF THE INVENTION

1. Field of the invention

Apparatuses and methods consistent with the present invention relate to a dual carrier modulator for modulating an orthogonal frequency division multiplexing (OFDM) carrier, an OFDM transmitter using the same and a method thereof, and more particularly to a dual carrier modulator generating a modulated symbol in which coded bits are disposed in a real part and an imaginary part of the modulated symbol, an OFDM transmitter using the same, and a method thereof.

2. Description of the Related Art

Ultra Wide Band (UWB) wireless technology enables high-speed data transmission using hundreds of MHz band. An OFDM is one of the technologies for embodying such UWB communication. By using sub-carriers of hundreds or thousands of different frequencies, the OFDM is capable of compressing larger quantity of information in each symbol period compared to a digital data transmission system, and transmitting the compressed information. Consequently, the OFDM is capable of transmitting the same number of bits per minute with fewer symbols in comparison with the other digital data transmission system.

According to various standards regarding the OFDM, the OFDM symbol modulating methods include quadrature phase-shift keying (QPSK), binary phase-shift keying (BPSK), 16-quadrature amplitude modulation (QAM), and 64-QAM. According to the multiband OFDM alliance (MBOA) physical (PHY) Layer 0v95 standard, a DCM method is used.

For the DCM, a dual carrier modulator receives 200 coded bits, detects 4 bits among the 200 coded bits in a predetermined order, and converts the detected bits to a modulated symbol using an orthogonal matrix. More specifically, such a conventional DCM method generates the modulated symbol through [Equation 1] as below:

$$[ \begin{matrix} {y}_{n} \\ {y}_{n + 50}\end{matrix} ] = \frac{1}{\sqrt{10}} [ \begin{matrix}2 & 1 \\ 1 & - 2\end{matrix} ] [ \begin{matrix} {x}_{a ( n )} + {jx}_{a ( n ) + 50} \\ {x}_{a ( n ) + 1} + {jx}_{a ( n ) + 51}\end{matrix} ] \\ a ( n ) = [ \begin{matrix} 2 n & when , n = 0 , 1 , 2 , … , 24 \\ 2 n + 50 & when , n = 25 , 26 , … , 49\end{matrix} ] \qquad [ Equation 1 ]$$

In [Equation 1], 1/√\overline{10} refers to a normalization factor, yₙ refers to the modulated symbol, and xₐ₍ₙ₎ refers to the coded bit.

FIG. 1 is a diagram for explaining processes of generating the modulated symbol in a conventional dual carrier modulator. Referring to FIG. 1, the dual carrier modulator receives x₀˜x₁₉₉ coded bits. The dual carrier modulator generates a 1^{st} modulated symbol y₀ and a 51^{st} modulated symbol y₅₀ using x₀, x₁, x₅₀, and x₅₁ of the coded bits. The x₀ and x₁ are placed at a real part of each of y₀ and y₅₀ while x₅₀ and x₅₁ are placed at an imaginary part of each of y₀ and y₅₀.

According to an OFDM transmitter using the conventional dual carrier modulator, therefore, the coded bits x₀ to x₄₉ and x₁₀₀ to x₁₄₉ are transmitted through a channel In-phase (I), and the coded bits x₅₀ to x₁₄₉ and x₁₅₀ to x₁₉₉ through a channel Quadrature (Q). Therefore, when I/Q mismatching is generated due to noise inserted in one of the channels I and Q, signal loss may be caused.

### SUMMARY OF THE INVENTION

The present invention provides a dual carrier modulator capable of preventing loss of signal even when I/Q mismatching is generated, by disposing a coded bit in a real part of one modulated symbol and an imaginary part of another modulated symbol using a unitary matrix, an OFDM transmitter using the same, and a method thereof.

According to an aspect of the present invention, there is provided a dual carrier modulator comprising an input part receiving a predetermined number of coded bits; a memory part storing the coded bits received through the input part; a detection part detecting four bits among the coded bits in a predetermined order; and an operation part performing an operation generating a modulated symbol comprising a real part and an imaginary part, using the four detected bits and a predetermined unitary matrix. Here, one of the coded bits is included in a real part of a first modulated symbol and an imaginary part of a second modulated symbol.

According to another aspect of the present invention, there is provided an OFDM transmitter comprising a coder coding a predetermined data stream and outputting a predetermined number of coded bits; a dual carrier modulator detecting four bits among the coded bits in a predetermined order and performing an operation generating two modulated symbols comprising a real part and an imaginary part, using the four detected bits and a predetermined unitary matrix; and a fast Fourier transformer (FFT) fast-Fourier-transforming and outputting the modulated symbol. Here, one of the coded bits is included in a real part of a first modulated symbol and an imaginary part of a second modulated symbol.

A method for transmitting OFDM symbols in an OFDM transmitter according to a yet another of the present invention, comprises generating a predetermined number of coded bits by coding a predetermined data stream; detecting four bits among the coded its in a predetermined order; generating a modulated symbol comprising a real part and an imaginary part by performing operation using the four detected bits and a predetermined unitary matrix; and fast-Fourier-transforming the modulated symbol and outputting the transformed modulated symbol. Here, one of the coded bits is also included in a real part of a first modulated symbol and in an imaginary part of a second modulated symbol.

### BRIEF DESCRIPTION OF THE DRAWING FIGURES

The above and other aspects of the present invention will become more apparent by describing in detail exemplary embodiments thereof with reference to the attached drawing figures, wherein;

FIG. 1 is a diagram for explaining a conventional dual carrier modulation (DCM);

FIG. 2 is a block diagram for illustrating the structure of a dual carrier modulator according to an exemplary embodiment of the present invention;

FIG. 3 is an exemplary diagram for explaining a modulation method of the dual carrier modulator of FIG. 2;

FIG. 4 is an exemplary table showing patterns of a modulated symbol generated using coded bits in the dual carrier modulator of FIG. 2;

FIG. 5 is a block diagram showing the structure of an OFDM transmitter according to an exemplary embodiment of the present invention; and

FIG. 6 is a flowchart for explaining a method for transmitting OFDM symbol, according to an exemplary embodiment of the present invention.

### DETAILED DESCRIPTION OF THE EXEMPLARY EMBODIMENTS

Hereinafter, an exemplary embodiment of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

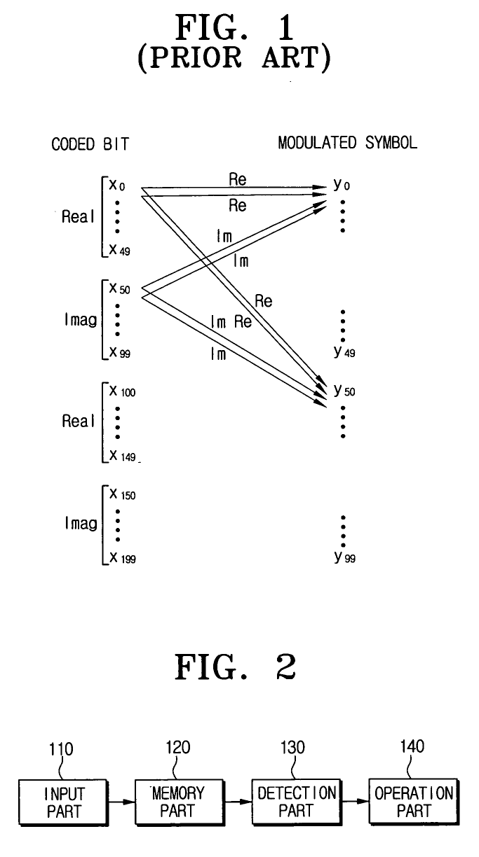

FIG. 2 is a block diagram showing the structure of a dual carrier modulator according to an exemplary embodiment of the present invention. Referring to FIG. 2, the dual carrier modulator comprises an input part 110, a memory part 120, a detection part 130, and an operation part 140.

The input part 110 receives coded bits output from a predetermined coder. According to the MBOA PHY Layer 0v95 standard, the input part 110 receives totally 200 coded bits.

The memory part 120 stores the received coded bits.

The detection part 130 detects four of the coded bits stored in the memory part 120 in a predetermined order. More specifically, for example, 1^{st}, 2^{nd}, 51^{st} and 52^{nd} coded bits are detected to generate 1^{st} and 51^{st} modulated symbols. When generating 2^{nd} and 52^{nd} modulated symbols, 3^{rd}, 4^{th}, 53^{rd} and 54^{th} coded bits are detected. When generating 25^{th} and 75^{th} modulated symbols, 100^{th}, 101^{st}, 150^{th} and 151^{th} coded bits are detected. When generating 26^{th} and 76^{th} modulated symbols, 102^{nd}, 103^{rd}, 152^{nd} and 153^{rd} coded bits are detected.

The operation part 140 disposes the four bits detected by the detection part 130 in a real part and an imaginary part, respectively. For this, the operation unit 140 uses a unitary matrix. More specifically, the operation part 140 generates the modulated symbol using [Equation 2] as follows:

$$[ \begin{matrix} {y}_{n} \\ {y}_{n + 50}\end{matrix} ] = [ UM ] [ \begin{matrix} {x}_{a ( n )} + {jx}_{a ( n ) + 50} \\ {x}_{a ( n ) + 1} + {jx}_{a ( n ) + 51}\end{matrix} ] \\ [ UM ] = N [ \begin{matrix}α & β \\ - β j & α j\end{matrix} ] \\ a ( n ) = [ \begin{matrix} 2 n & when , n = 0 , 1 , 2 , … , 24 \\ 2 n + 50 & when , n = 25 , 26 , … , 49\end{matrix} ] \qquad [ Equation 2 ]$$

In [Equation 2], yₙ refers to the modulated symbol, xₐ₍ₙ₎ refers to the coded bit, [UM] refers to the unitary matrix, N refers to a normalization factor, and α and β refer to constant numbers. As can be appreciated from [Equation 2], the unitary matrix includes an imaginary number ‘j’ in the second row. Accordingly, the coded bits can be included in the real part and the imaginary part of the modulated symbol, respectively.

For balance with the modulated symbols in the dual carrier modulator according to the MBOA PHY Layer 0v95 standard, it is preferable, but not necessary, that N, α, and β remain 1/√\overline{10}, 1 and 2, respectively. [Equation 2] can be reorganized using such values, as follows:

$$[ \begin{matrix} {y}_{n} \\ {y}_{n + 50}\end{matrix} ] = \frac{1}{\sqrt{10}} [ \begin{matrix}1 & 2 \\ - 2 j & j\end{matrix} ] [ \begin{matrix} {x}_{a ( n )} + {jx}_{a ( n ) + 50} \\ {x}_{a ( n ) + 1} + {jx}_{a ( n ) + 51}\end{matrix} ] \qquad [ Equation 3 ]$$

As the operation part 140 performs operations through [Equation 2] or [Equation 3], x₀ to x₄₉ among the coded bits are included in the real parts of y₀ to y₂₄ and the imaginary parts of y₅₀ to y₇₄, respectively. The coded bits x₅₀ to x₉₉ are included in the imaginary parts of y₀ to y₂₄ and the real parts of y₅₀ to y₇₄, respectively. The coded bits x₁₀₀ to x₁₄₉ are included in the real parts of y₂₅ to y₄₉ and the imaginary parts of y₇₅ to y₉₉, respectively. In addition, the coded bits x₁₅₀ to x₁₉₉ are included in the imaginary parts of y₂₅ to y₄₉ and the real parts of y₇₅ to y₉₉, respectively. Accordingly, all the coded bits are transmitted through both I and Q channels.

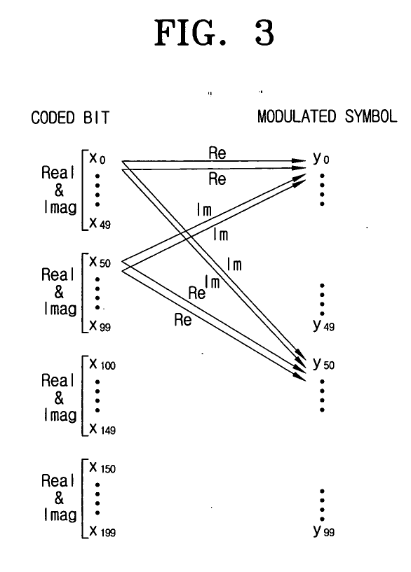

FIG. 3 is a diagram for explaining processes for generating the modulated symbols by the dual carrier modulator of FIG. 2. According to FIG. 3, x₀ and x₁ are included in both the real part of y₀ and the imaginary part of y₅₀. The dual carrier modulator thus generates the modulated symbols using the unitary matrix.

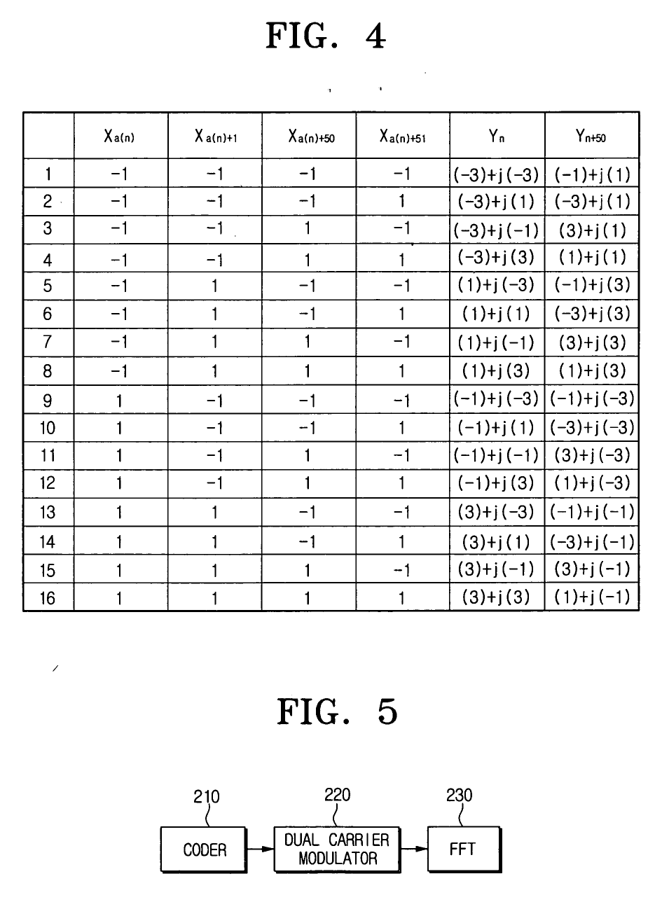

FIG. 4 is a table illustrating the modulated symbols generated in the dual carrier modulator of FIG. 2. Referring to FIG. 4, xₐ₍ₙ₎ and xₐ₍ₙ₎₊₁ are included in the real part of yₙ and the imaginary part of yₙ₊₅₀, and xₐ₍ₙ₎₊₅₀ and xₐ₍ₙ₎₊₅₁ are included in the imaginary part of yₙ and the real part of yₙ₊₅₀.

FIG. 5 is a block diagram showing the structure of the OFDM transmitter according to an exemplary embodiment of the present invention. Referring to FIG. 5, the OFDM transmitter comprises a coder 210, a dual carrier modulator 220, and an FFT 230.

The coder 210 codes a data stream to be transmitted, thereby outputting a coded bit. More particularly, the coded bit may be generated through a convolution coding method.

The dual carrier modulator 220 modulates the coded bit output from the coder 210 using [Equation 2] or [Equation 3], thereby outputting modulated symbol. Since the structure and the operation of the dual carrier modulator 220 have been described with reference to FIG. 2, detailed description thereof will not be repeated.

The FFT 230 fast-Fourier transforms the modulated symbol to an OFDM symbol. The FFT method and other OFDM symbolizing method will not be described in detailed since those are generally known.

As a result, all the coded bits can be transmitted through the channels I and Q.

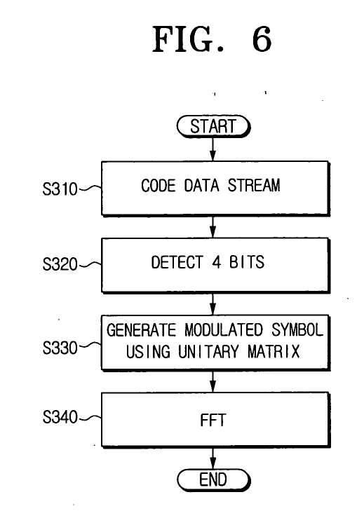

FIG. 6 is a flowchart for explaining a method for transmitting OFDM symbol, according to an exemplary embodiment of the present invention. According to FIG. 6, the data stream is coded, thereby generating the coded bits (S310). In this case, puncturing and interleaving operations may be performed. The puncturing reduces the number of bits to be transmitted by methodically and partly omitting the coded bits before transmission, and the interleaving prevents deterioration of error correction function caused by generation of a burst error.

Four bits among the generated coded bits are detected (S320) and converted to the modulated symbols using [Equation 2] or [Equation 3] (S330). Next, the modulated symbols are fast-Fourier transformed (S340), thereby generating and transmitting the OFDM symbols.

As can be appreciated from the above description, according to an exemplary embodiment of the present invention, a coded bit is disposed in the real part of one modulated symbol and the imaginary part of the other modulated symbol using the unitary matrix. Accordingly, loss of signals can be prevented although I/Q mismatching occurs.

While the invention has been shown and described with reference to certain embodiments thereof, it will be understood by those skilled in the art that various changes in form and details may be made therein without departing from the spirit and scope of the invention as defined by the appended claims.

What is claimed is:

1. A dual carrier modulator comprising:
an input part which receives a predetermined number of coded bits;
a memory part which stores the coded bits received through the input part;
a detection part which detects four bits among the coded bits in a predetermined order; and
an operation part which generates a modulated symbol comprising a real part and an imaginary part, using the four detected bits and a predetermined unitary matrix.

2. The dual carrier modulator of claim 1, wherein one of the detected four bits is included in a real part of a first modulated symbol and an imaginary part of a second modulated symbol.

3. The dual carrier modulator of claim 1, wherein the operation part generates the modulated symbol using following equations:
$$[ \begin{matrix} {y}_{n} \\ {y}_{n + 50}\end{matrix} ] = [ UM ] [ \begin{matrix} {x}_{a ( n )} + {jx}_{a ( n ) + 50} \\ {x}_{a ( n ) + 1} + {jx}_{a ( n ) + 51}\end{matrix} ] \\ [ UM ] = N [ \begin{matrix}α & β \\ - β j & α j\end{matrix} ]$$
$$a ( n ) = [ \begin{matrix} 2 n & when , n = 0 , 1 , 2 , … , 24 \\ 2 n + 50 & when , n = 25 , 26 , … , 49\end{matrix} ]$$
wherein, yₙ refers to the modulated symbol, xₐ₍ₙ₎ refers to one of the coded bits, [UM] refers to the unitary matrix, N refers to a normalization factor, and α and β refer to constant numbers. .

4. The dual carrier modulator of claim 3, wherein the unitary matrix is expressed by a following equation:
$$[ UM ] = \frac{1}{\sqrt{10}} [ \begin{matrix}1 & 2 \\ - 2 j & j\end{matrix} ] .$$

5. An orthogonal frequency division multiplexing (OFDM) transmitter comprising:
a coder which codes a predetermined data stream and outputs a predetermined number of coded bits;
a dual carrier modulator which detects four bits among the coded bits in a predetermined order and generates a modulated symbol comprising a real part and an imaginary part, using the four detected bits and a predetermined unitary matrix; and
a fast Fourier transformer (FFT) which fast-Fourier-transforms and outputs the modulated symbol.

6. The OFDM transmitter of claim 5, wherein one of the detected four bits is included in a real part of a first modulated symbol and an imaginary part of a second modulated symbol.

7. The OFDM transmitter of claim 5, wherein the dual carrier modulator generates the modulated symbol using following equations:
$$[ \begin{matrix} {y}_{n} \\ {y}_{n + 50}\end{matrix} ] = [ UM ] [ \begin{matrix} {x}_{a ( n )} + {jx}_{a ( n ) + 50} \\ {x}_{a ( n ) + 1} + {jx}_{a ( n ) + 51}\end{matrix} ] \\ [ UM ] = N [ \begin{matrix}α & β \\ - β j & α j\end{matrix} ]$$
$$a ( n ) = [ \begin{matrix} 2 n & when , n = 0 , 1 , 2 , … , 24 \\ 2 n + 50 & when , n = 25 , 26 , … , 49\end{matrix} ]$$
wherein, yₙ refers to the modulated symbol, xₐ₍ₙ₎ refers to one of the coded bits, [UM] refers to the unitary matrix, N refers to a normalization factor, and α and β refer to constant numbers.

8. The OFDM transmitter of claim 7, wherein the unitary matrix is expressed by a following equation:
$$[ UM ] = \frac{1}{\sqrt{10}} [ \begin{matrix}1 & 2 \\ - 2 j & j\end{matrix} ] .$$

9. A dual carrier modulation method, comprising:
receiving a predetermined number of coded bits;
detecting four bits among the coded bits in a predetermined order; and
generating a modulated symbol comprising a real part and an imaginary part, using the four detected bits and a predetermined unitary matrix.

10. The method of claim 9, wherein one of the detected four bits is included in a real part of a first modulated symbol and an imaginary part of a second modulated symbol.

11. The method of claim 9, wherein generating of the modulated symbol using the four detected bits and a predetermined unitary matrix is performed by following equations:
$$[ \begin{matrix} {y}_{n} \\ {y}_{n + 50}\end{matrix} ] = [ UM ] [ \begin{matrix} {x}_{a ( n )} + {jx}_{a ( n ) + 50} \\ {x}_{a ( n ) + 1} + {jx}_{a ( n ) + 51}\end{matrix} ] \\ [ UM ] = N [ \begin{matrix}α & β \\ - β j & α j\end{matrix} ]$$
$$a ( n ) = [ \begin{matrix} 2 n & when , n = 0 , 1 , 2 , … , 24 \\ 2 n + 50 & when , n = 25 , 26 , … , 49\end{matrix} ]$$
wherein, yₙ refers to the modulated symbol, xₐ₍ₙ₎ refers to one of the coded bits, [UM] refers to the unitary matrix, N refers to a normalization factor, and α and β refer to constant numbers.

12. The method of claim 11, wherein the unitary matrix is expressed by a following equation:
$$[ UM ] = \frac{1}{\sqrt{10}} [ \begin{matrix}1 & 2 \\ - 2 j & j\end{matrix} ] .$$

13. A method for transmitting orthogonal frequency division multiplexing (OFDM) symbols in an OFDM transmitter, comprising:
generating a predetermined number of coded bits by coding a predetermined data stream;
detecting four bits among the coded bits in a predetermined order;
generating a modulated symbol comprising a real part and an imaginary part, using the four detected bits and a predetermined unitary matrix; and
fast-Fourier-transforming the modulated symbol and outputting the transformed modulated symbol.

14. The method of claim 13, wherein one of the detected four bits is included in a real part of a first modulated symbol and an imaginary part of a second modulated symbol.

15. The method of claim 13, wherein generating of the modulated symbol uses following equations:
$$[ \begin{matrix} {y}_{n} \\ {y}_{n + 50}\end{matrix} ] = [ UM ] [ \begin{matrix} {x}_{a ( n )} + {jx}_{a ( n ) + 50} \\ {x}_{a ( n ) + 1} + {jx}_{a ( n ) + 51}\end{matrix} ] \\ [ UM ] = N [ \begin{matrix}α & β \\ - β j & α j\end{matrix} ]$$
$$a ( n ) = [ \begin{matrix} 2 n & when , n = 0 , 1 , 2 , … , 24 \\ 2 n + 50 & when , n = 25 , 26 , … , 49\end{matrix} ]$$
wherein, yₙ refers to the modulated symbol, xₐ₍ₙ₎ refers to one of the coded bits, [UM] refers to the unitary matrix, N refers to a normalization factor, and α and β refer to constant numbers.

16. The method of claim 15, wherein the unitary matrix is expressed by a following equation:
$$[ UM ] = \frac{1}{\sqrt{10}} [ \begin{matrix}1 & 2 \\ - 2 j & j\end{matrix} ] .$$
